(19) United States
(12) Patent Application Publication
(10) Pub. No.: US 2026/0313237 A1
(43) Pub. Date: Oct. 8, 2026

(54) LENS APPARATUS, IMAGE PICKUP APPARATUS, CAMERA SYSTEM, PROCESSING METHOD, AND STORAGE MEDIUM

(71) Applicant: CANON KABUSHIKI KAISHA, Tokyo (JP)

(72) Inventor: Hideki SAKAI, Tochigi (JP)

(21) Appl. No.: 19/564,274

(22) Filed: Mar. 12, 2026

(30) Foreign Application Priority Data
Apr. 8, 2025 (JP) 2025-063419

(51) Int. Cl. H04N 23/69; G03B 17/14; H04N 23/55; H04N 23/63

(52) U.S. Cl. CPC H04N 23/69; H04N 23/55; H04N 23/631; H04N 23/633; G03B 17/14

(57) ABSTRACT

A lens apparatus may be attachable to an image pickup apparatus and include a first transmitter configured to transmit to the image pickup apparatus first information on a function of the lens apparatus and second information on a plurality of options of a state of the function, and a first receiver configured to receive from the image pickup apparatus third information on a first option selected in the image pickup apparatus from the plurality of options.

### BACKGROUND

### Field of the Technology

The present disclosure relates to a lens apparatus, an image pickup apparatus, a camera system, a processing method, and a storage medium.

### Description of the Related Art

Conventionally, an image pickup apparatus capable of setting a variety of functions depending on a type of an interchangeable lens has been known. For example, Japanese Patent No. 7,237,534 discloses a configuration that displays on a display apparatus information for setting functions expanded by an expansion unit, when the expansion unit corresponding to an interchangeable lens is connected to an information processing apparatus corresponding to an image pickup apparatus.

However, in the configuration disclosed in Japanese Patent No. 7,237,534, the information processing apparatus previously recognizes settable functions when the expansion unit is connected, and stores in advance information to be displayed on the display apparatus. That is, the information processing apparatus is unable to display or set functions of an expansion unit whose functions are not previously known to the information processing apparatus.

### SUMMARY

A lens apparatus according to one aspect of the present disclosure may be attachable to an image pickup apparatus and include a first transmitter configured to transmit to the image pickup apparatus first information on a function of the lens apparatus and second information on a plurality of options of a state of the function, and a first receiver configured to receive from the image pickup apparatus third information on a first option selected in the image pickup apparatus from the plurality of options. An image pickup apparatus according to another aspect of the present disclosure to which the above lens apparatus may be attachable include a second receiver configured to receive the first information and the second information from the lens apparatus, a display unit configured to display the first information and the second information while the second receiver receives the first information and the second information, and a second operation member used to select the first option. A camera system according to another aspect of the present disclosure may include the above lens apparatus and the image pickup apparatus. A processing method according to another aspect of the present disclosure for a lens apparatus attachable to an image pickup apparatus may include transmitting to the image pickup apparatus first information on a function of the lens apparatus and second information on a plurality of options of a state of the function, and receiving from the image pickup apparatus third information on a first option selected in the image pickup apparatus from the plurality of options. A storage medium storing a program that causes a computer to execute the above processing methods also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of a camera system according to one embodiment of the present disclosure.

FIG. 2 is a flowchart illustrating a processing method of a lens apparatus according to a first embodiment.

FIG. 3 is a conceptual diagram illustrating an operation of an imaging system.

FIG. 4 is a flowchart illustrating a processing method of a lens apparatus according to a second embodiment.

FIG. 5 is a flowchart illustrating a processing method of an imaging system according to a third embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the present disclosure. Corresponding elements in respective figures will be designated by the same reference numerals, and a duplicate description thereof will be omitted.

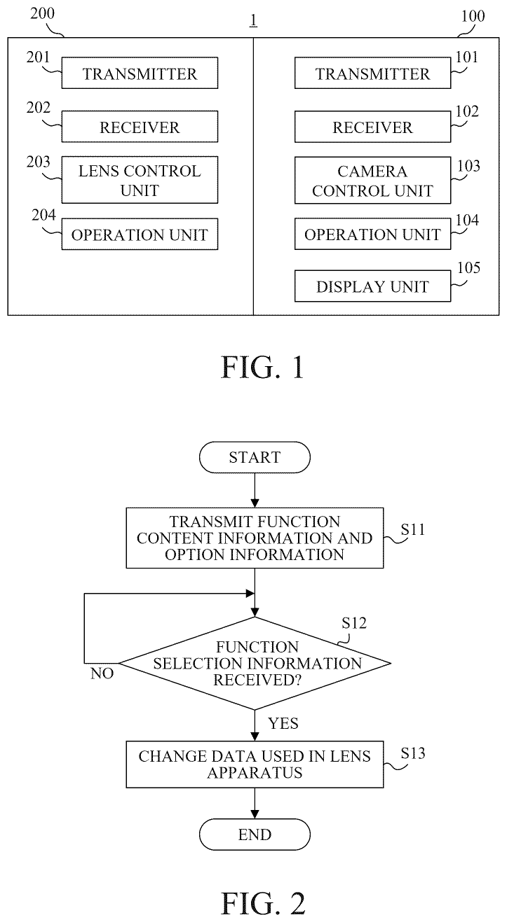

FIG. 1 is a block diagram of an imaging system (camera system) 1 according to an embodiment of the present disclosure. The imaging system 1 includes an image pickup apparatus 100 such as a digital camera or a digital video camera, and a lens apparatus (interchangeable lens) 200 that is attachable to and detachable from the image pickup apparatus 100.

The lens apparatus 200 includes a transmitter (first transmitter) 201, a receiver (first receiver) 202, a lens control unit (setting unit) 203, and an operation unit (first operation unit) 204. The lens apparatus 200 further includes an optical system (not illustrated). The optical system includes at least one lens unit. The lens unit may include an aperture stop (diaphragm).

The transmitter 201 is configured to transmit function content information (first information) on functions of the lens apparatus 200. The function content information is information that describes functions provided by the lens apparatus 200. In the present embodiment, the function content information is information represented by characters (character string information), as illustrated in Table 1. The function content information may be character information of 4 bytes or more. Thereby, the information can be displayed as it is on a display unit or the like of the image pickup apparatus 100 to describe an operation or purpose of the function to a user. The function content information may be character information of 8 bytes or more in order to describe the function more accurately, and may be character information of 32 bytes or more to support languages such as Japanese. The transmitter 201 is configured to transmit to the image pickup apparatus 100 option information (second information) on a plurality of options (function options) of a function state. The option information is information in which a plurality of options representing possible states of a function described by the function content information are listed. The option information includes a plurality of options for each function, as illustrated in Table 1. In the present embodiment, each option is character information, as illustrated in Table 1 as an example. Each option may be character information of 4 bytes or more. Thereby, the option can be displayed as it is on the display unit or the like of the image pickup apparatus 100 to explain the function state to a user. Each option may be represented by character information of 8 bytes or more in order to describe a state of a function more accurately, and may be represented by character information of 32 bytes or more in order to support languages such as Japanese.

In the present embodiment, the function content information and the option information are character information; however, the information may alternatively be information represented by an image (image information).

The receiver 202 is configured to receive from the image pickup apparatus 100 function selection information (third information) on an option (first option) selected in the image pickup apparatus 100 from among the plurality of options. The lens control unit 203 controls overall operation of the lens apparatus 200. The lens control unit 203 is configured to set at least one of data (information) used in the lens apparatus 200 and a function corresponding to the operation unit 204, according to the function selection information. The lens control unit 203 is further configured to control at least one of a lens unit, an aperture diameter of an aperture stop, and a zoom position according to the function selection information.

The image pickup apparatus 100 includes a transmitter (second transmitter) 101, a receiver (second receiver) 102, a camera control unit 103, an operation unit (second operation unit) 104, and a display unit (display unit) 105. The image pickup apparatus 100 further includes an image sensor (not illustrated) that receives an image formed by an optical system.

TABLE 1

| Function Content | Option Information of function State | | | | | | | | | |
|---|---|---|---|---|---|---|---|---|---|---|
| Information | Option 1 | | Option 2 | | Option 3 | | Option 4 | | Option 5 | |
| SA Control | −2 | | −1 | | 0 | | 1 | | 2 | |
| EDGE BOKE | OFF | | ON | | | | | | | |
| Control | | | | | | | | | | |
| DIST Control | linear | | high dist | | max dist | | | | | |
| VIG Control | brightest | | brighter | | darker | | darkest | | | |
| | vignetting | | vignetting | | vignetting | | vignetting | | | |
| Soft Filter/ | Normal | | Classic | | Soft Focus | | EF50F1.0 | | | |
| Classic Lens | | | Lens−like | | Lens−like | | | | | |
| Simulator Mode | | | | | | | | | | |
| FNO Extension | F2.0 | | F2.4 | | F2.8 | | F3.5 | | F4.0 | |
| ZOOM Extension | 105 | mm | 135 | mm | 150 | mm | 200 | mm | 300 | mm |
| AF Adjust (1 m) | −5 | cm | −2 | cm | −1 | cm | −0.5 | cm | 0 | cm |

| Function Content | Option Information of function State | | | | Function Selection |
|---|---|---|---|---|---|
| Information | Option 6 | Option 7 | Option 8 | Option 9 | Information |
| SA Control | | | | | 3 |
| EDGE BOKE | | | | | 1 |
| Control | | | | | |
| DIST Control | | | | | 1 |
| VIG Control | | | | | 1 |
| Soft Filter/ | | | | | 1 |
| Classic Lens | | | | | |
| Simulator Mode | | | | | |
| FNO Extension | | | | | 3 |
| ZOOM Extension | | | | | 1 |
| AF Adjust (1 m) | +0.5 cm | +1 cm | +2 cm | +5 cm | 3 |

The receiver 102 is configured to receive the first information and the second information from the lens apparatus 200. The display unit 105 displays the first information and the second information received by the receiver 102 as received (in the state received by the receiver 102). The operation unit 104 is used to select a first option from among a plurality of options. In a case where the first option is selected using the operation unit 104, the transmitter 101 transmits function selection information on the first option to the lens apparatus 200.

### First Embodiment

The present embodiment will discuss an example in which the lens apparatus 200 transmits function content information and option information to the image pickup apparatus 100 and changes (sets) data used in the lens apparatus 200 in a case where the function selection information is changed.

FIG. 2 is a flowchart illustrating a processing method of the lens apparatus 200 according to the present embodiment. This flow is executed by the lens control unit 203 in a case where the lens apparatus 200 is attached to the image pickup apparatus 100.

In step S11, the lens control unit 203 causes the transmitter 201 to transmit the function content information and the option information to the image pickup apparatus 100.

In step S12, the lens control unit 203 determines whether the receiver 202 has received function selection information from the image pickup apparatus 100. In a case where the receiver 202 has received the function selection information, the flow proceeds to the processing of step S13; otherwise, the flow repeats the processing of step S12.

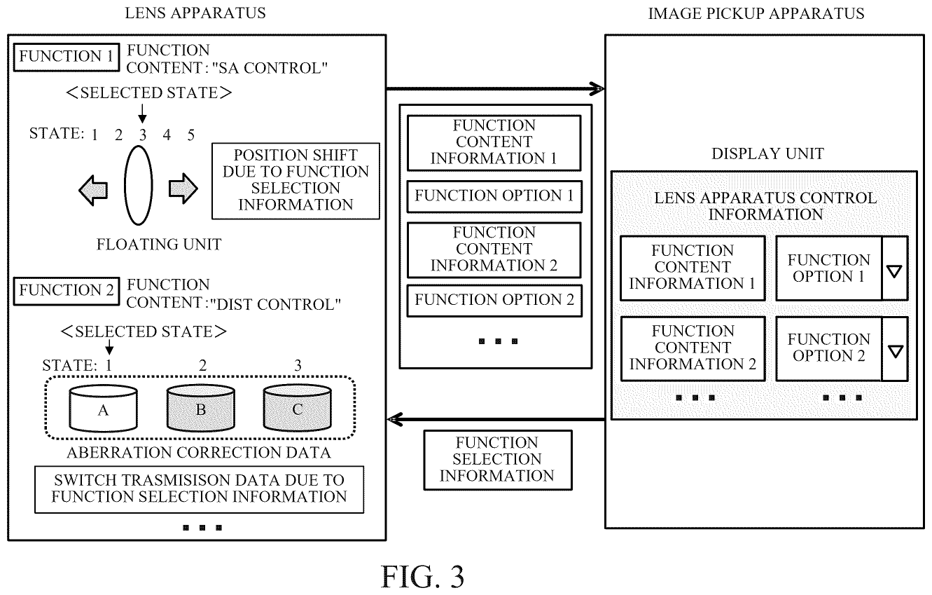

In step S13, the lens control unit 203 changes data used in the lens apparatus 200 in accordance with the function selection information. Thereby, the type of data to be changed and resulting behavior of the lens apparatus 200 differ depending on the function, as illustrated in FIG. 3. For example, in a case where data on a position of a floating unit is changed, the position of the floating unit under the same condition is changed, thereby affecting imaging of the lens apparatus 200. In a case where aberration correction information to be transmitted to an external device is changed, the state of the lens apparatus 200 itself does not change.

### Second Embodiment

In the present embodiment, in addition to the configuration of the first embodiment, an example is described in which the function selection information is stored in a memory of the lens apparatus 200.

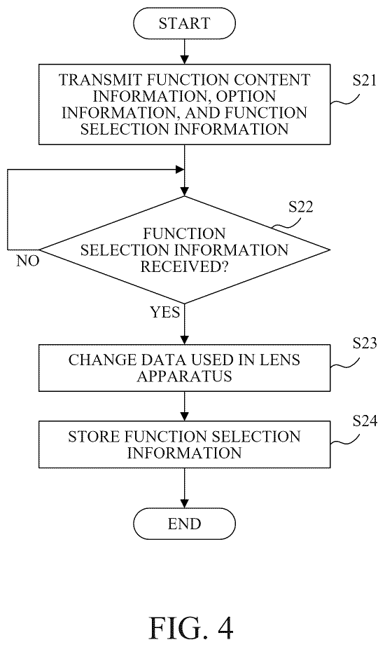

FIG. 4 is a flowchart illustrating a processing method of the lens apparatus 200 according to the present embodiment. The processing is executed by the lens control unit 203 when the lens apparatus 200 is attached to the image pickup apparatus 100.

In step S21, the lens control unit 203 causes the transmitter 201 to transmit the function content information and the option information to the image pickup apparatus 100, and further causes the transmitter 201 to transmit the function selection information stored in the memory of the lens apparatus 200 to the image pickup apparatus 100.

In step S22, the lens control unit 203 determines whether the receiver 202 has received function selection information from the image pickup apparatus 100. In a case where the receiver 202 receives the function selection information from the image pickup apparatus 100, the flow proceeds to step S23; otherwise, the flow repeats the processing of step S22.

In step S23, the lens control unit 203 changes data used in the lens apparatus 200 in accordance with the function selection information.

In step S24, the lens control unit 203 stores the function selection information in the memory of the lens apparatus 200. Thereby, when the lens apparatus 200 is subsequently activated, a previously selected function information is stored, the function state can be reproduced in the lens apparatus 200 and the state can be transmitted to the image pickup apparatus 100. Since the image pickup apparatus 100 can receive the current function state of the lens apparatus 200 when it is started, even when it is attached to another external apparatus, the image pickup apparatus 100 can suppress inconsistency with the lens apparatus 200.

### Third Embodiment

In the present embodiment, operations of both the image pickup apparatus 100 and the lens apparatus 200 are described.

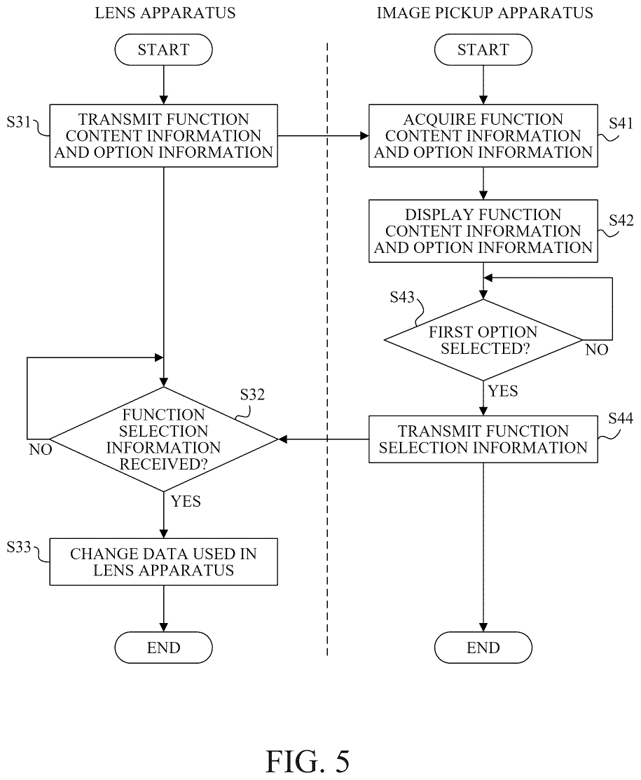

FIG. 5 is a flowchart illustrating a processing method of the imaging system 1. Processing in the lens apparatus 200 is executed by the lens control unit 203, and processing in the image pickup apparatus 100 is executed by the camera control unit 103.

In step S31, the lens control unit 203 causes the transmitter 201 to transmit the function content information and the option information. In a case where the function selection information is stored in the memory (not illustrated) of the lens apparatus 200, the function selection information may also be transmitted to the image pickup apparatus 100.

Steps S32 and S33 are the same as steps S22 and S23 and thus a description thereof will be omitted in detail.

In step S41, the camera control unit 103 acquires information transmitted from the lens apparatus 200 via the receiver 102.

In step S42, the camera control unit 103 causes the display unit 105 to display the function content information and option information acquired in step S41. Since the information is character information, as illustrated in Table 1, and the information can be displayed as it is, even when the image pickup apparatus 100 does not have prior knowledge of the function, it can be displayed. As long as the options are standard options such as ON/OFF, the image pickup apparatus 100 can use options that are stored in advance in the image pickup apparatus 100. In addition, in a case where the image pickup apparatus 100 acquires function selection information from the lens apparatus 200, the image pickup apparatus 100 can display the options in a state in which an option selected by the function selection information is selected (selected state), thereby indicating a state of the lens apparatus 200 to a user.

In step S43, the camera control unit 103 determines whether the first option has been selected from among the plurality of options via the operation unit 104. In a case where the camera control unit 103 determines that the first option has been selected, it executes the processing of step S44, and in a case where it determines that the first option has not been selected, it repeats the processing of this step. In a case where the display unit 105 displays the option selected in the function selection information in the selected state, it may also determine whether the selected option has been changed.

In step S44, the camera control unit 103 causes the transmitter 101 to transmit to the lens apparatus 200 the function selection information on the first option selected in step S43.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide a lens apparatus, an image pickup apparatus, a camera system, a processing method, and a storage medium, each of which can display and set a function of the lens apparatus even when the function is not previously recognized by the image pickup apparatus.

This application claims the benefit of Japanese Patent Application No. 2025-063419, filed on Apr. 8, 2025, which is hereby incorporated by reference herein in its entirety.

What is claimed is:

1. A lens apparatus attachable to an image pickup apparatus, the lens apparatus comprising:
a first transmitter configured to transmit to the image pickup apparatus first information on a function of the lens apparatus and second information on a plurality of options of a state of the function; and
a first receiver configured to receive from the image pickup apparatus third information on a first option selected in the image pickup apparatus from the plurality of options.

2. The lens apparatus according to claim 1, wherein the first information includes character information.

3. The lens apparatus according to claim 2, wherein the first information includes character information of 4 bytes or more.

4. The lens apparatus according to claim 1, wherein each of the plurality of options includes character information.

5. The lens apparatus according to claim 4, wherein each of the plurality of options includes character information of 4 bytes or more.

6. The lens apparatus according to claim 1, wherein the first transmitter transmits to the image pickup apparatus the information on the state of the function stored in the lens apparatus, before the first receiver receives the third information.

7. The lens apparatus according to claim 1, further comprising a setting unit configured to set information used in the lens apparatus according to the third information.

8. The lens apparatus according to claim 1, further comprising:
a first operation unit; and
a setting unit configured to set a function corresponding to the first operation unit according to the third information.

9. The lens apparatus according to claim 1, further comprising:
at least one lens unit;
one or more memories storing instructions; and
one or more processors that, upon execution of the instructions, operate to control the at least one lens unit according to the third information.

10. The lens apparatus according to claim 1, further comprising:
an aperture stop;
one or more memories storing instructions; and
one or more processors that, upon execution of the instructions, operate to control an aperture diameter of the aperture stop according to the third information.

11. The lens apparatus according to claim 1, further comprising:
one or more memories storing instructions; and
one or more processors that, upon execution of the instructions, operate to control a zoom position according to the third information.

12. An image pickup apparatus to which the lens apparatus according to claim 1 is attachable, the image pickup apparatus comprising:
a second receiver configured to receive the first information and the second information from the lens apparatus;
a display unit configured to display the first information and the second information while the second receiver receives the first information and the second information; and
a second operation member used to select the first option.

13. The image pickup apparatus according to claim 12, wherein the second receiver receives the information on the state of the function set in the lens apparatus, and
wherein the display unit displays the second information while an option corresponding to the information on the state of the function is selected from the plurality of options.

14. The image pickup apparatus according to claim 12, further comprising a second transmitter configured to transmit the third information to the lens apparatus when the first option is selected.

15. A camera system comprising:
the lens apparatus according to claim 1; and
an image pickup apparatus.

16. A processing method for a lens apparatus attachable to an image pickup apparatus, the processing method comprising:
transmitting to the image pickup apparatus first information on a function of the lens apparatus and second information on a plurality of options of a state of the function; and
receiving from the image pickup apparatus third information on a first option selected in the image pickup apparatus from the plurality of options.

17. A non-transitory computer-readable storage medium storing a program that causes a computer to execute the processing method according to claim 16.
